(19) United States
(12) Patent Application Publication
(10) Pub. No.: US 2026/0283078 A1
(43) Pub. Date: Sep. 24, 2026

(54) SYSTEM AND METHOD FOR IRRADIATING A PLURALITY OF PLANTS

(71) Applicant: SIGNIFY HOLDING B.V., EINDHOVEN (NL)

(72) Inventors: LEONIE MARIA GEERDINCK, EINDHOVEN (NL); THIJS VAN DEN BERGH, WAALRE (NL)

(21) Appl. No.: 19/484,398

(22) PCT Filed: Apr. 29, 2024
(86) PCT No.: PCT/EP2024/061754

§ 371 Date: Nov. 14, 2025

(30) Foreign Application Priority Data
May 15, 2023 (EP) 23173453.4

(51) Int. Cl. A01G 7/04

(52) U.S. Cl. CPC A01G 7/045

(57) ABSTRACT

Systems and methods are disclosed for irradiating a plurality of plants based on a chlorophyll A/B ratio in at least one of the plurality of plants. The system comprises an irradiation system for irradiating the plurality of plants and a data processing system. The irradiation system comprises one or more controllable radiation sources, and/or one or more controllable radiation filters and/or radiation concentrators. The data processing system is configured to receive or determine a ratio between chlorophyll A and chlorophyll B in at least one of the plurality of plants. The data processing system is further configured to cause the irradiation system to irradiate the plurality of plants in accordance with a first radiation recipe before a switching moment, and in accordance with a second radiation recipe, different from the first radiation recipe, after the switching moment. At least the switching moment depends on the ratio between chlorophyll A and chlorophyll B.

### TECHNICAL FIELD

This disclosure relates to a system and method for irradiating a plurality of plants, in particular, to such system wherein the plurality of plants is irradiated in dependence on a chlorophyll A/B ratio and/or a total carotenoids concentration in the plurality of plants. This disclosure further relates to a computer-implemented method for configuring an irradiation system to irradiate the plurality of plants and to a computer program and computer-readable storage medium for performing such method.

### BACKGROUND

Indoor production of food in vertical farms (VF) is only economically viable in case plant growth can be done year-round in an efficient way. Key value drivers are crop quality, for example post-harvest shelf-life, and Light Use Efficiency (LUE, typically expressed in gram of harvested crop per mol of photons), which relates the biomass production to the integral amount of light used for the production, as well as crop quality. Here, the term “light” also encompasses non-visible parts of the electromagnetic spectrum, such as (near) infrared and (near) ultraviolet.

However, crop quality and light use efficiency often require different radiation recipes. For example, it is known that for the growth of, e.g., lettuce, adding Far-Red (FR) radiation to the standard Deep-Red Blue (DRB) spectrum induces stretching of leaves. With this increased leaf area, more light can be intercepted, leading to faster biomass production (and hence an increased light use efficiency). However, this addition of far red in the spectrum might result in a decreased quality in terms of crop quality, e.g., plant morphology, pigment concentration and shelf life. A higher blue dose has an opposite effect on morphology as far-red does. A higher blue dose reduces the final fresh weight significantly, makes plants more compact, and may reduce the number of leaves per plant or canopy area.

Currently, in vertical farming, radiation recipes are specifically optimized per crop and, in most situations, stay constant during growth. This is in particular so for food production. However, there is ample evidence that plants could benefit from different radiation treatments depending on their growth phase. In particular, in the last days before harvest, plants can benefit from a so-called pre-harvest treatment (e.g., with additional blue in the spectrum) to improve quality, for example to create coloration, to increase vitamin C content or to reduce nitrate content. Often, the use of plant-phase-dependent radiation recipes increases not only plant quality, but also improves light use efficiency. Light use efficiency can be further improved using dimmable and color-controllable light fixtures, which are recently becoming available. This way, plant yield and plant quality can be balanced.

Radiation recipes, both constant ones and plant-phase-dependent ones, are currently typically based on destructive analyses at the end of a growth cycle of the plant.

Such analyses are used to determine various parameters such as, for instance, fresh weight (g/plant), yield (g/m²) and light use efficiency (g/mol), as well as post-harvest quality assessments, like dry matter percentage and shelf-life. These parameters are then used to retrospectively determine ideal dynamic light recipes in the different growth phases of each crop.

In light of the above, there is a need in the art for a system and method for irradiating a plurality of plants that increases light use efficiency and/or crop quality.

CN 111684946 A discloses a plant culture system comprising a plurality of lighting modules, each providing a different light spectrum. Each of the plurality of lighting modules is configured to provide a specific light spectrum and spectral intensity that matches the absorption of a specific combination and amount (incl. ratio) of photosynthetic pigments in plants. The document discloses that combinations and amounts (incl. ratios) of different photosynthetic pigments in plants differ between different plants and between different growth stages of the same plant. Based on this, the plant culture system pairs specific light spectra and spectral intensities, and therewith specific lighting modules, with specific plant types and growth stages and selects a lighting module for illuminating plants based on a particular plant type and growth stage.

### SUMMARY

To that end, a system for irradiating a plurality of plants based on a chlorophyll A/B ratio in at least one of the plurality of plants is disclosed. The system comprises an irradiation system that is configured to irradiate the plurality of plants and a data processing system, communicatively connected to the irradiation system. The irradiation system comprises one or more controllable radiation sources, and/or one or more controllable radiation filters and/or radiation concentrators. A controller is configured to control operation of the one or more controllable radiation sources and/or the one or more controllable radiation filters and/or the radiation concentrators. The data processing system is configured to receive or determine a ratio between chlorophyll A and chlorophyll B in at least one of the plurality of plants. The data processing system is further configured to cause the irradiation system to irradiate the plurality of plants in accordance with a first radiation recipe before a switching moment, and in accordance with a second radiation recipe, different from the first radiation recipe, after the switching moment. The switching moment depends on the ratio between chlorophyll A and chlorophyll B. The period of irradiating the plurality of plants in accordance with the first radiation recipe before the switching moment may also be referred to as a first period of time. The period of irradiating the plurality of plants in accordance with the second radiation recipe after the switching moment may also be referred to as a second period of time.

With such a system, it is possible to steer on the chlorophyll A/B ratio, i.e., the ratio between chlorophyll A and chlorophyll B, in the plants. The inventors have noted that shelf life of a plant product is positively correlated with the chlorophyll A/B ratio. The inventors furthermore found that the chlorophyll A/B ratio can be influenced by the radiation recipes used. Thus, by monitoring the chlorophyll A/B ratio and adjusting the radiation recipe accordingly, shelf life may be adjusted (typically increased).

However, radiation recipes that lead to an increase in chlorophyll A/B ratio typically have a lower light use efficiency (LUE) than radiation recipes that lead to a decrease in chlorophyll A/B ratio. Therefore, the system may be configured to strike a balance between light use efficiency and shelf life. For example, the system may be configured to maximize light use efficiency while maintaining at least a predetermined chlorophyll A/B ratio (and hence ensure a minimum shelf life), or the system may be configured to maximize the chlorophyll A/B ratio (and hence shelf life) whilst not exceeding a predetermined light use efficiency.

The plants in the plurality of plants can be plants that are grown for their leaves, such as cannabis, tobacco, leafy vegetables, or herbs. Examples of leafy vegetables include lettuce, rocket, spinach, endive, cabbage, et cetera. Example of herbs include basil, parsley, cilantro, et cetera.

In an aspect, this disclosure relates to a horticulture arrangement comprising such a system. The term “horticulture arrangement” especially refers to an arrangement including a plant support wherein or whereon plants may grow, an irradiation system that is configured to direct (horticulture) radiation to the plant support wherein or whereon the plants may grow (or grow), and a control system that controls the (horticulture) radiation. The control system may comprise or be communicatively connected to the data processing system.

In use, the horticulture arrangement may include a plant support with a plant, or a plant support with a seed, or a plant support with a seedling, etc. Herein, the term “plant” is used for essentially all stages of plant development.

Radiation for growth of plants typically comprises a mixture of red and blue radiation. Red radiation may be understood as radiation having a wavelength between 600-750 nm, whereas blue radiation may be understood as radiation having a wavelength between 400-500 nm. In particular, the term “horticulture radiation” especially refers to radiation having one or more wavelengths in one or more of a first wavelength range of 625-675 nm and a second wavelength range of 400-475 nm. The relative energies (Watt) that are provided in these ranges may depend upon the type of plant and/or the growth phase. Hence, a recipe may define the ratio, optionally as a function of time, for one or more types of plants. Especially, the term “horticulture radiation” may refer to the PAR range (the photosynthetically active radiation in the wavelength range from 400-700 nm). The term “horticulture radiation” may also be used for radiation that is applied to plants in hydroponic applications. As known in the art, in the PAR wavelength range the reflection coefficient of leaves is very low (5-10%). Towards the near infrared, beyond 700 nm, the reflection coefficient increases. Hence, in specific embodiments, the horticulture radiation, may in addition to PAR radiation also include a small fraction (e.g., ≤25 % of the power, especially about at maximum 10 % of the power) far red, i.e., 700-850 nm.

When pre-harvest radiation is offered, this is generally used to stress the plants such that the plants will respond by producing some compound of interest (e.g., nutritional content, colorants, taste compounds, et cetera). Such pre-harvest radiation typically contains a large fraction of blue radiation (e.g., about 450 nm), and/or UV-A radiation (e.g., 385-405 nm) and/or radiation levels in excess of 50 μmol m⁻²s⁻¹. In some cases, UV-B radiation can also be applied beneficially. In general, plants may be sensitive both to absolute intensities of certain wavelengths and to relative intensities between different wavelengths.

The term “horticulture arrangement” may also refer to a plant farm or climate cell, wherein the plants are grown under controlled conditions, and wherein the plants substantially do not receive natural radiation (daylight). Further, such plant farm may be climatized, such as in the case of a climate cell. Hence, in embodiments, the horticulture arrangement includes such plant farm or climate cell. In other embodiments, the plant farm or climate cell includes at least part of the horticulture arrangement. For instance, a climate cell may comprise the plant support and the irradiation system, and the control system may be configured inside or external from the climate cell. Especially, a plant farm may comprise a climate cell.

The control system of such horticulture arrangement may control one or more of temperature, humidity, CO₂ level, irrigation, nutrient supply, radiation intensity of the horticulture radiation, air conditions including one or more of air temperature, air composition, air flow, etc. Such horticulture system may be configured to control one or more of these conditions at different locations in the arrangement. Hence, the irradiation with the horticulture radiation may in embodiments be done in response to, e.g., one or more of time of the day, season of the year, (local) irradiation conditions, age of plant, condition of the plant, planting period, etc. Hence, the irradiation with the horticulture radiation may in embodiments be done in response to plant related data, time related parameters, conditions to which the plant is subjected (such as natural radiation, temperature, relative humidity, CO₂ level, irrigation, nutrient supply, etc.).

The horticulture irradiation system is especially configured to provide horticulture radiation to plants. This may especially imply that the horticulture irradiation system is configured to provide horticulture radiation in a direction of a plant support wherein or whereon plants may grow. Such plant support may be a tray. Especially, the term “plant support” may also refer to a plurality of plant supports, as the plants may be grown in layers one above the other (“multi-layer system”). Hence, racks with each two or more plant supports, with overarching each plant support an irradiation system. Hence, the term “irradiation system” may also refer to a plurality of (individually controlled) irradiation systems.

Further, the control system is configured to control one or more of a radiation intensity, a spectral distribution, and a spectral power distribution of the horticulture radiation. The term “controlling” and similar terms especially refer at least to determining the behavior or supervising the operation of an element. Hence, herein “controlling” and similar terms may, e.g., refer to imposing, regulating or guiding a behavior or operation of an element, and may include, e.g., measuring, displaying, actuating, opening, shifting, changing temperature, etc. Hence, the term “controlling” and similar terms may additionally include monitoring. Hence, in the context of horticulture radiation, “controlling” may refer to regulating or guiding the operation of a horticulture irradiation system to effect one or more of a radiation intensity, a spectral distribution, and a spectral power distribution of horticulture radiation.

The phrase “one or more of a radiation intensity, a spectral distribution and spectral power distribution of the horticulture radiation” may refer to the total intensity, i.e. the power, of the horticulture radiation, especially in the visible, provided by the irradiation system. However, in specific embodiments the control system may also be configured to control the spectral distribution, e.g., reducing or increasing parts of the spectral wavelength range relative to other parts of the spectral wavelength range, in such case an intensity in each spectral wavelength range may be controlled as reflected in the term ‘spectral power distribution’. In embodiments the control system may be configured to control one or more of the intensity, the spectral distribution and the spectral power distribution of the horticulture radiation, for instance in dependence of the one or more optical sensor signals.

As indicated above, the control system is configured to control one or more of a radiation intensity, a spectral distribution and a spectral power distribution of horticulture radiation in dependence of the chlorophyll A/B ratio in at least one of the plants in the horticulture arrangement.

The controllable radiation sources may include, e.g., LED radiation sources, HID radiation sources, laser radiation sources, or other suitable radiation sources. The one or more controllable radiation sources may include means for controlling the interaction of the radiation with the plants, e.g., through filtering and/or concentrating the generated radiation, and/or through modifying the interaction time with, the plants. For example, different radiation wavelengths may invoke different physiological processes in the plant. As another example, different intensities of radiation may invoke different dynamics of physiological processes in plants. As a further example, different timing of radiation or different exposure times of plants to radiation may effect growth and/or crop quality parameters. The radiation filters may be configured to selectively block, in part or in full, radiation of one or more predetermined wavelength ranges. The radiation concentrators may be configured to concentrate radiation on the plants, e.g., using a lens or mirror. Filters and concentrators can also be combined, e.g., by wavelength conversion, reducing an intensity of radiation of a first wavelength (filtering) while increasing an intensity of radiation of a second wavelength (concentrating).

The one or more radiation filters may have, for instance, controllable radiation filtering properties and/or a controllable position. Similarly, the one or more radiation concentrators may have, for instance, controllable radiation concentrating properties and/or a controllable position. The controllable position may allow the filters and/or concentrators to be selectively inserted and removed between a radiation source and the plants.

In an embodiment, the data processing system is further configured to receive or determine an absolute or relative threshold value. The data processing system may be further configured to cause the irradiation system to switch between the first radiation recipe and the second radiation recipe, in response to the data processing system determining that the ratio between chlorophyll A and chlorophyll B is below the threshold value.

In a typical embodiment, the first radiation recipe has the effect of ensuring rapid growth of the plurality of plants, at the cost of a decrease of the chlorophyll A/B ratio. The second radiation recipe typically has the effect of increasing the chlorophyll A/B ratio.

Thus, in an embodiment, the first radiation recipe has a higher light use efficiency (LUE) than the second radiation recipe. Additionally, or alternatively, the second radiation recipe may have higher crop quality increasing properties, in particular higher shelf-life increasing properties, than the first radiation recipe. This way, a good balance between light use efficiency and crop quality can be struck.

In an embodiment, the first radiation recipe comprises a higher red and/or far-red radiation dose or fraction than the second radiation recipe. Additionally, or alternatively, the first radiation recipe may comprise a lower blue and/or ultraviolet radiation dose or fraction than the second radiation recipe. For example, the first radiation recipe may have a higher intensity of red and/or far-red radiation, and/or a longer duration of red and/or far-red radiation, and/or a higher fraction of red and/or far-red radiation (compared to e.g. blue and/or ultraviolet radiation) in comparison with the second radiation recipe. Similarly, the first radiation recipe may have a lower intensity of blue and/or ultraviolet radiation, and/or a shorter duration of blue and/or ultraviolet radiation, and/or a lower fraction of blue and/or ultraviolet radiation (compared to e.g. red and/or far-red radiation) in comparison with the second radiation recipe.

Conversely, the second radiation recipe may have a higher intensity of blue and/or ultraviolet radiation, and/or a longer duration of blue and/or ultraviolet radiation, and/or a higher fraction of blue and/or ultraviolet radiation (compared to e.g. red and/or far-red radiation) in comparison with the first radiation recipe. Similarly, the second radiation recipe may have a lower intensity of red and/or far-red radiation, and/or a shorter duration of red and/or far-red radiation, and/or a lower fraction of red and/or far-red radiation (compared to e.g. blue and/or ultraviolet) in comparison with the first radiation recipe.

In general, radiation recipes with a high (far) red radiation dose have a higher light use efficiency but induce lower crop quality properties, whereas radiation recipes with a high blue radiation dose have a lower light use efficiency but induce higher crop quality properties.

In an embodiment, the far-red radiation intensity, dose, and/or fraction in the first radiation recipe is determined based on the ratio between chlorophyll A and chlorophyll B.

In an embodiment, the blue and/or ultraviolet radiation intensity, dose, and/or fraction in the second radiation recipe is determined based on the ratio between chlorophyll A and chlorophyll B.

In an embodiment, the far-red radiation intensity, dose, and/or fraction in the first radiation recipe is at least twice as high as, respectively the far-red radiation intensity, dose, and/or fraction in the second radiation recipe.

In an embodiment, the blue and/or ultraviolet radiation intensity, dose, and/or fraction in the second radiation recipe is at least twice as high as, respectively, the blue and/or ultraviolet radiation intensity, dose, and/or fraction in the first radiation recipe.

In an embodiment, the threshold value is an absolute threshold value, preferably having a value between 2.5 and 3.5, preferably between 2.6 and 3.0. It has been found that an absolute threshold value in this range for the chlorophyll A/B ratio strikes a favorable balance between light use efficiency and shelf life. The threshold value may be specific to the plant or variety being grown.

An advantage of using an absolute threshold value is that it is relatively easy to determine and does not require determination of an initial chlorophyll A/B ratio against which a reduction in the chlorophyll A/B ratio is evaluated.

In an embodiment, the threshold value is a relative threshold value, preferably defined as a fraction of an initial ratio between chlorophyll A and chlorophyll B, preferably the fraction being between 0.7 and 0.97, more preferably between 0.8 and 0.95. It has been found that such relative threshold values for the chlorophyll A/B ratio strikes a favorable balance between light use efficiency and shelf life.

An advantage of using a relative threshold value is that it is easier to generalize between different species or varieties of plants, or different growing circumstances.

In an embodiment, the data processing system is configured to receive or determine a concentration of carotenoids in at least one of the plurality of plants. In such an embodiment, at least one of the first radiation recipe, the second radiation recipe, or the switching moment may depend on the concentration of carotenoids.

The total amount per unit mass (or concentration) of carotenoids in the plants appears to have a similar relation with shelf life as the chlorophyll A/B ratio. Therefore, the total amount of carotenoids may be determined and used in a similar fashion, in addition to or instead of the chlorophyll A/B ratio.

In an embodiment, the ratio between chlorophyll A and chlorophyll B is determined from one or more samples obtained from the at least one plant. This allows accurate measurement of the chlorophyll A and B concentrations and is very versatile in selection of the plant part to be sampled from.

In particular, determining the ratio between chlorophyll A and chlorophyll B may comprise extracting the sample in a defined amount of solvent, and measuring absorption of the solvent using a UV/VIS spectrophotometer at a plurality of predetermined wavelengths. A UV/VIS spectrophotometer is a spectrophotometer that can be used to perform spectrometry in at least part of the ultraviolet (UV) and/or visible (VIS) spectrum. The predetermined wavelength may correspond to absorption peaks of chlorophyll A and B, and/or to wavelengths which have a large relative difference in absorption by chlorophyll A and B.

In an embodiment, the ratio between chlorophyll A and chlorophyll B is determined using near infrared (NIR) spectroscopy. This allows non-destructive measurement of the chlorophyll A and chlorophyll B concentrations. Moreover, when a camera system or a near-infrared spectroscopy sensor is used, essentially continuous monitoring of the chlorophyll A and chlorophyll B concentrations is possible. The camera system or a near-infrared spectroscopy sensor may be comprised in the data processing system described above.

In an embodiment, each of the first and second radiation recipes defines, for a particular time period, one or more properties of radiation (to be) provided to the plurality of plants.

The one or more properties of radiation may comprise at least one of:
a photon flux of the radiation as generated by the irradiation system,
a photon flux density of the radiation as received by the plurality of plants,
a spectral power distribution of the radiation generated by the irradiation system, and
a timing of the radiation.

The timing of the radiation may refer to the photoperiod (expressed as, e.g., a number of hours per day) and/or to the schedule of the radiation (i.e., at which hours of the day).

In such an embodiment, the data processing system may be configured to cause the irradiation system to generate radiation such that the radiation has the photon flux and/or photon flux density and/or the spectral power distribution and/or the timing of the radiation as defined by first radiation recipe and/or the second radiation recipe (also sometimes referred to herein as a pre-harvest radiation recipe).

The timing of the radiation may include temporal variation of the photon flux (density) and/or spectral power distribution, and/or the duration of the radiation. The photon flux may be defined, e.g., in μmol/(m²s), or in any other useful quantity.

The data processing system may comprise a communication interface to receive a ratio between chlorophyll A and chlorophyll B in at least one of the plurality of plants or to receive data related to a chlorophyll A and chlorophyll B in the at least one of the plurality of plants. The communication interface may further be configured to receive one or more of the above-described threshold values. The data processing may further comprise one or more processors to, if applicable, determine a ratio between chlorophyll A and chlorophyll B based on the received data related to a chlorophyll A and chlorophyll B in the at least one of the plurality of plants, compare the chlorophyll A/B ratio with one or more threshold value, determine or select a radiation recipe based on the comparison and generate control signals for the irradiation system to execute the radiation recipe. The communication interface may be configured to send the control signals to the irradiation system, therewith causing the irradiation system to irradiate the plurality of plants in accordance with the first radiation recipe or the second radiation recipe. Instead of a communication interface for receiving and sending data, the data processing system may also comprise input/output devices for performing these functions. The data processing system may further comprise a memory for storing radiation recipes and one or more threshold values, to be used by the one or more processors.

The irradiation system may comprise one or more radiation sources and controller to control the operation of these one or more radiation sources. Controlling the operation of these one or more radiation sources may include controlling an intensity, a spectrum and/or a spectral power distribution of the radiation emitted by the one or more radiation sources. In an embodiment, each of the one or more radiation sources may be individually controllable in terms of intensity, spectrum and/or a spectral power distribution of radiation emitted. The controller may comprise a communication interface or input/output device for communicating with the data processing system and receive control signals. The controller may also control the controllable radiation filters and/or radiation concentrators to control the radiation emitted to and/or irradiation received by the plurality of plants.

Phrases like “the data processing system is configured to cause the irradiation system to irradiate the plurality of plants in accordance with a radiation recipe” may therefore be embodied using the processor and communication features of the data processing system and irradiation system of the system, as described above.

In an aspect, the disclosure relates to a method for irradiating a plurality of plants. The method may comprise: receiving or determining a ratio between chlorophyll A and chlorophyll B in at least one of the plurality of plants, and causing the irradiation system to irradiate the plurality of plants in accordance to a first radiation recipe before a switching moment, and in accordance to a second radiation recipe, different from the first radiation recipe, after the switching moment, wherein the switching moment depends on the ratio between chlorophyll A and chlorophyll B. The method may be executed using the data processing system and irradiation system of the system described above.

Thus, a system as described above may be controlled using this method. The method may be, at least partially, executed, for example, by the data processing system of the system described above.

One aspect of this disclosure relates to a computer comprising a computer readable storage medium having computer readable program code embodied therewith, and a processor, preferably a microprocessor, coupled to the computer readable storage medium, wherein responsive to executing the computer readable program code, the processor is configured to perform, at least partially, any of the methods disclosed herein.

One aspect of this disclosure relates to a computer program or suite of computer programs comprising at least one software code portion or a computer program product storing at least one software code portion, the software code portion, when run on a computer system, being configured for executing, at least partially, any of the methods disclosed herein.

One aspect of this disclosure relates to a non-transitory computer-readable storage medium storing at least one software code portion, the software code portion, when executed or processed by a computer, is configured to perform, at least partially, any of the methods disclosed herein.

The invention is defined by the appended independent claims. Preferred embodiments are further defined in the appended dependent claims.

As will be appreciated by one skilled in the art, aspects of the present invention may be embodied as a system, a method or a computer program product.

Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Javal, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer 13 adionnected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products as claimed in embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products as claimed in various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Moreover, a computer program for carrying out the methods described herein, as well as a non-transitory computer readable storage-medium storing the computer program are provided. A computer program may, for example, be downloaded (updated) to the existing systems (e.g., to the existing control systems) or be stored upon manufacturing of these systems.

Elements and aspects discussed for or in relation with a particular embodiment may be suitably combined with elements and aspects of other embodiments, unless explicitly stated otherwise. Embodiments of the present invention will be further illustrated with reference to the attached drawings, which schematically will show embodiments as claimed in the invention. It will be understood that the present invention is not in any way restricted to these specific embodiments.

### BRIEF DESCRIPTION OF THE DRAWINGS

Aspects of the invention will be explained in greater detail by reference to exemplary embodiments shown in the drawings, in which:

FIG. 1 schematically illustrates a system for irradiating a plurality of plants based on a chlorophyll A/B ratio according to an embodiment;

FIGS. 2A and 2B are flow charts illustrating embodiments of a method for irradiating a plurality of plants;

FIG. 3 is a flow chart illustrating another embodiment of the method for irradiating a plurality of plants;

FIG. 4 is a graph showing the effect of light spectrum on shelf-life for wild rocket;

FIG. 5 is a graph representing the absorption spectrum of chlorophyll A, chlorophyll B and total carotenoids in leaves, respectively;

FIG. 6 is a graph showing the relation between the relative amount of far-red in the radiation recipe and the chlorophyll A/B ratio;

FIG. 7 is a graph showing the effect of a pre-harvest treatment on the total concentration of carotenoids in rocket; and

FIG. 8 illustrates a data processing system according to an embodiment.

### DETAILED DESCRIPTION OF THE DRAWINGS

In the figures, identical reference numbers indicate identical or similar elements.

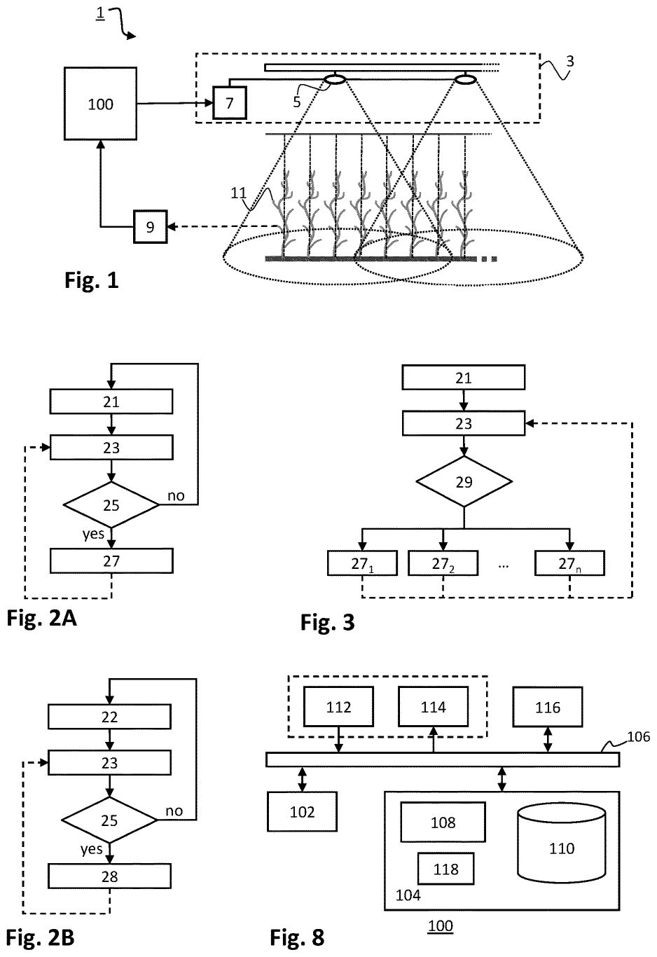

FIG. 1 schematically illustrates a system for irradiating a plurality of plants based on a chlorophyll A/B ratio in at least one of the plurality of plants according to a first embodiment. The system 1 comprises an irradiation system 3 that is configured to irradiate the plurality of plants 11. The irradiation system comprises a plurality of controllable radiation sources 5. The controllable radiation sources may comprise, e.g., a plurality of individually or group-wise controllable LEDs. In this example, the radiation sources 5 are controlled by controller 7. The radiation sources may be configured to provide horticulture radiation, such as radiation for crop growth. The controller may control one or more of: a radiation intensity, a spectral distribution and spectral power distribution of the horticulture radiation.

The system also comprises a data processing system 100, communicatively connected to the irradiation system 3. In particular, the data processing system may comprise a processor 102 configured to generate control signals for the irradiation system 3 and the data processing system 100 may, via a communication interface 116, be configured to transmit the control signals to the controller 7 of the irradiation system 3, which controller may be configured to receive said control signals and control the radiation sources 5 accordingly.

The control signals may be of different types. In one embodiment, the control signals may be representative for a radiation recipe to be executed by the irradiation system 3. In another embodiment, the control signals may be representative of drive signals to control the radiation output from the one or more radiation sources 5 of the irradiation system 3. Other types of control signals may be selected, depending on the functionality of the controller 7 of the irradiation system 3 and how the controller 7 interfaces with the data processing system 100.

The data processing system 100 is configured to receive, using the communication interface 116 or the input device 112, or determine, using the processor 102, a parameter representative of or based on a chlorophyll A/B ratio in at least one of the plurality of plants 11. In the depicted embodiment, the data processing system 100 receives a parameter representative of the chlorophyll A/B ratio from an analyzer 9. In some embodiments, the analyzer 9 may be part of the data processing system 100. The parameter may be based on a measurement of a single sample or can be a statistical representation of a plurality of samples, e.g., a mean, median, minimum, or maximum value. Alternatively, the data processing system 100 may configured to receive, using the communication interface 116 or the input device 112 one or more parameters representative of the chlorophyll A and the chlorophyll B, e.g., as derived from a measuring device or manually obtained from a user or plant expert, and determine, using the processor 102, a parameter representative of the chlorophyll A/B ratio. As a further alternative, the data processing system 100 may be configured to receive, using the communication interface 116 or the input device 112, one or more parameter representative of or based on a chlorophyll A, a chlorophyll B or a chlorophyll A/B ratio in one or more of the plants from an operator or user of the system 1.

The data processing system 100 is further configured to cause the irradiation system 3 to irradiate the plurality of plants in dependence on the chlorophyll A/B ratio by generating, by the processor 102, one or more control signals based on the received or determined chlorophyll A/B ratio and sending, via the communication interface 116, the one or more control signals to the irradiation system 3. For example, the data processing system 100 may generate and communicate one or more control signals to cause the irradiation system 3 to switch from a first radiation recipe to a second radiation recipe, different from the first radiation recipe. In a typical example, the first radiation recipe is optimized for light use efficiency and comprises a relatively large amount of red and/or far-red radiation, whereas the second radiation recipe is optimized to increase the chlorophyll A/B ratio and comprises a relative large amount of blue radiation. At least one of the first radiation recipe, the second radiation recipe, or the switching moment depends on the ratio between chlorophyll A and chlorophyll B.

The data processing system 100 can be further configured to receive, using the communication interface 116 or the input device 112, or determine, using the processor 102, an absolute or relative threshold value. In such case, the switch between the first radiation recipe and the second radiation recipe may be activated in response to the processor 102 of the data processing system 100 determining that the chlorophyll A/B ratio has crossed the threshold value, for example by determining that the chlorophyll A/B ratio is below the threshold value.

Thus, the system 1 may be configured to balance light use efficiency and shelf life of the plurality of plants (or parts thereof). This may be done, for instance, by first applying a radiation recipe with a high (far) red fraction, leading to a high light use efficiency and fast growth, but a (temporary) decrease in shelf life. Subsequently, e.g., prior to harvest, a radiation recipe with a low red fraction and a high blue fraction may be applied, increasing the shelf life. The amount of blue radiation in the sec 17 adiationation recipe may be determined based on the chlorophyll A/B ratio, and/or the timing of the switching may be based on the chlorophyll A/B ratio.

An example of a data processing system is discussed in more detail below with reference to FIG. 8.

The irradiation system 3 may comprise at least one radiation source 5. In a typical embodiment, the irradiation system comprises a plurality of radiation sources 5, typically controllable radiation sources, e.g., LEDs, for generating a controllable intensity and/or spectral distribution and/or spectral power distribution of artificial radiation. Additionally, or alternatively, the irradiation system 3 may comprise one or more controllable radiation filters and/or radiation concentrators to further control an intensity and/or spectral distribution and/or spectral power distribution of generated artificial radiation. Such filters and/or concentrators can be used, for example, to control aspects of the irradiation that cannot be sufficiently controlled by the radiation sources themselves.

The irradiation system 3 may further comprise a controller 7. The controller 7 may comprise a processor and a memory communicatively coupled to the processor. The irradiation system 3 may comprise a communication interface to enable communication with data processing system 100.

The irradiation system 3 is configurable, via the controller 7 and the at least one radiation source 5, to apply at least the first radiation recipe and the second radiation recipe to the plurality of plants 11. The second radiation recipe may be applied (immediately) prior to harvesting the plants 11.

The controllable radiation sources can be, e.g., LED radiation sources, HID radiation sources, or other suitable radiation sources. The one or more controllable radiation sources may include a natural radiation source (e.g., daylight) with controlling means, e.g., screens in a greenhouse, to control the intensity and/or spectrum of radiation from the natural radiation source interacting with the plants, e.g., through filtering and/or concentrating the natural radiation. In some embodiments, the plants are grown in or on a tray which is moveable relative to the radiation sources; in such a system, the interaction time and/or duration of the plants with the radiation sources may be controlled (additionally or alternatively) through modifying the movement speed of the plants. The radiation filters may be configured to selectively block, in part or in full, radiation of one or more predetermined wavelength ranges. The radiation concentrators may be configured to concentrate radiation on the plants, e.g., using a lens or mirror. Filter and concentrators can also be combined, e.g., by wavelength conversion, reducing an intensity of radiation of a first wavelength (filtering) while increasing radiation of a second wavelength (concentrating).

Using such a system 1, pigment concentrations (e.g., carotenoid concentrations) and pigment ratios (e.g., a chlorophyll A/B ratio) may be monitored in order to be able to adjust radiation settings accordingly. This allows to improve light use efficiency (LUE) as well as post-harvest crop quality, like shelf-life.

In particular, the system can be used to monitor a decrease in chlorophyll A/B ratio, in a far-red rich spectrum, and an increase in chlorophyll A/B ratio in a high blue-spectrum. The radiation recipe may be adapted based on defined threshold values of such pigment concentrations and/or pigment ratios, guaranteeing a good post-harvest quality.

The idea is based on the knowledge that far-red radiation can increase growth speed, but typically also reduces crop quality, while a high blue-spectrum is known to keep plants more compact (i.e., reduce growth speed), but enhance antioxidant and photosynthetic pigment concentrations in leaves. Enhanced antioxidant concentrations potentially result in improved shelf life.

In general, two growth phases may be distinguished. In the first growth phase of leafy vegetables, when the first radiation recipe is applied, growth can be accelerated, but leaf pigmentation will decrease. The first radiation recipe typically comprises a relatively large amount, or at least a non-zero amount of far-red radiation. Depending on crop variety, radiation intensity and plant growth phase, the percentage far-red radiation might be adapted to minimize this decrease in pigments while maintaining a good, or at least acceptable, light use efficiency.

In the second (e.g., pre-harvest) phase, when the second radiation recipe is applied, pigment analysis can be used to monitor the increase in photosynthetic pigments (e.g., chlorophyll A and B) and antioxidant compounds (e.g., carotenoids). The second radiation recipe typically comprises a relatively large amount, or at least a non-zero amount of blue radiation. Depending on the situation, this pre-harvest treatments can be optimized from a light use efficiency and/or crop quality point of view.

It is noted that in some cases, more than two different radiation recipes may be used based on the development stage of the plants.

Thus, leaf pigment analysis, in particular the chlorophyll A/B ratio and/or total carotenoids concentration, are used as a tool to monitor crop quality during growth, allowing to adapt the radiation spectrum to optimize crop quality, while minimizing losses in light use efficiency.

It is noted that in current practice, leaf-clip devices such as the Dualex leafclip optical sensor (Metos, Pessl Instruments) or the MPM-100 Multi-Pigment-Meter (ADC Bioscientific) are typically used for pigment analysis. However, these devices are only capable of determining a total sum of chlorophyll (A+B) and concentrations of anthocyanin and flavonol in the leaves, but not the chlorophyll A/B ratio, nor the total amount of carotenoids.

Below, methods will be discussed to determine the chlorophyll A/B ratio, and/or the total amount of carotenoids, such as spectrophotometric absorption measurements from extracted leaf material.

For extraction, a small piece of leaf material (leaf disk) is taken by punching a hole in the leaf with a hollow drill. This material is extracted in a defined amount of solvent, e.g., 80% acetone, for a defined amount of time, e.g., at least 24 hours in a closed and dark environment. After extraction, the absorption of the solvent is measured using a UV/VIS spectrophotometer. Depending on the solvent, the pigment concentrations are calculated based on the absorption at three wavelengths (for 80% acetone, these wavelengths may be chosen as: 663, 646 and 470 nm); this is also shown in FIG. 5 (indicated with dash-dotted lines).

Alternatively, near-infrared (NIR) spectroscopy can be used to non-destructively analyze different organic compounds concentrations in the leaves. Other known methods to determine the chlorophyll A/B ratio and/or the total amount of carotenoids may also be used.

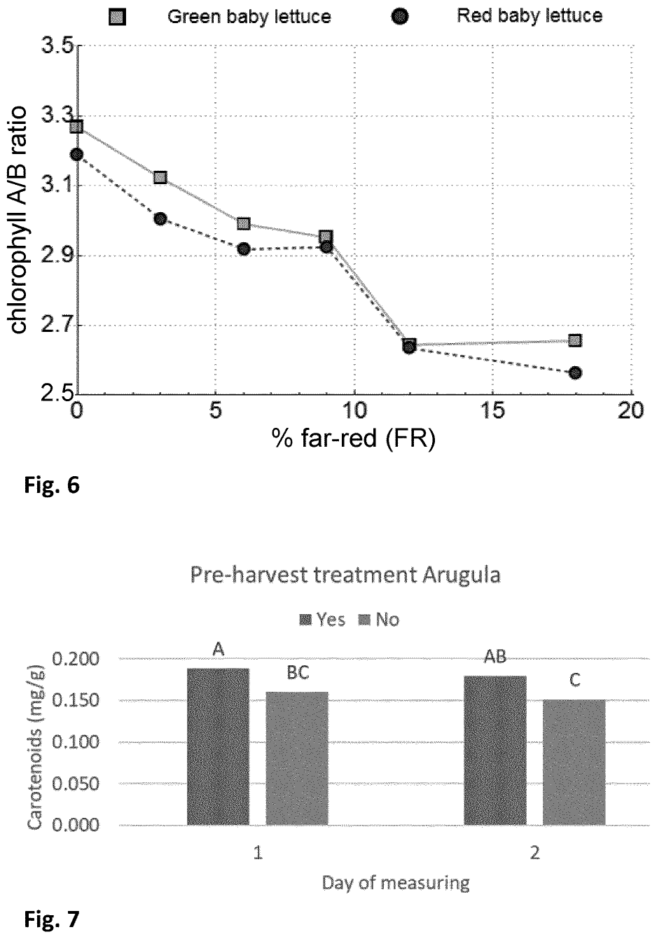

Research shows that with respect to a deep red +blue spectrum as a reference growth spectrum, an increased amount of far-red added in deep red +blue the spectrum decreases the chlorophyll A/B ratio, as well as the total carotenoids. Also, a decreased shelf life is seen in crops that are grown in spectra with high far-red percentages (see experimental results for red and green baby lettuce in FIG. 6 discussed further below). Furthermore, a pre-harvest treatment with an increased blue content increases antioxidant levels, such as for example the concentration total carotenoids (see pre-harvest versus no pre-harvest treatment of Arugula in FIG. 7 discussed further below).

Previously, pigment analyses were usually done at the end of growth. However, a single post-harvest analysis fails to take into account that absolute and relative pigment concentrations depend on, e.g., the crop, the growth phase, and the plant density, and hence change over time. For example, older leaves at a lower height in plants typically show a decreased pigment concentration and a decreased chlorophyll A/B ratio, possibly due to a lower red to far-red (R:FR) ratio of radiation deeper in the canopy.

Given the correlation between decreasing pigment ratios, in particular the chlorophyll A/B ratio, and shelf-life, intermediate pigment monitoring of the crop, during growth, can provide information to optimize radiation recipes, in particular for the growth phase. For example, below a certain threshold of pigment (ratio) values, it might be beneficial to increase the radiation intensity, the blue content, or to decrease the far-red content of the spectrum, to increase and keep the pigments and relative compounds above the threshold related to a good shelf life.

In an embodiment, the data processing system 100 (which may be part of an overall horticulture control system) acquires, via a communication interface 116 or input device 112, and analyses, via processor 102, pigment concentrations, in particular the chlorophyll A and B concentrations and/or the ratio thereof, and/or the total carotenoids concentration. A definition of pigment (ratio) threshold values can be part of a radiation recipe. Pigment (ratio) threshold values can also be inputted manually via an input device 112.

The threshold value can be an absolute threshold value, e.g., a chlorophyll A/B ratio threshold value can be 2.7. It has been found that absolute threshold values between 2.5 and 3.5, e.g., between 2.6 and 3.0 generally give good results. Alternatively, the threshold value can be a relative threshold value, for example defined as a fraction of an initial chlorophyll A/B ratio, e.g., the threshold may be reached at the point that the chlorophyll A/B ratio has been decreased more than 20% of its initial value. It has been found that a threshold value corresponding to a fraction between 0.7 and 0.97, e.g., between 0.8 and 0.95 of the initial value generally gives good results. Both types of threshold values and/or a combination of both types of threshold values may be used to determine the switching moment.

As soon as the threshold value is reached, the data processing system can instruct the irradiation system to switch off or lower (for example by a factor of at least 2) the far-red radiation, and/or increase radiation intensity, and/or increase the blue content of the spectrum. The radiation recipe may be optimized with respect to one or more different parameters, such as light use efficiency or shelf-life; thus, depending on the chosen optimization, the radiation recipes result in, e.g., an optimal yield with no or minimal loss in shelf-life, or an improved post-harvest quality with no or minimal loss in yield.

An automated feedback input from a monitoring system, such the herein-described data processing system, to a controlling system, such as the herein-described irradiation system can be used to automate the moment of switching radiation recipes. This is beneficial, because growth speed and metabolisms very much depends on species, varieties, and climate settings. The above may for example be implemented in a “Grow Wise Control System” from applicant.

Another advantage of automated quality monitoring is related to the fact that the moment of reaching a pigment (ratio) threshold becomes predictable if no changes in other growth parameters will occur in the meantime. This makes the further optimization with respect to light use efficiency and post-harvest quality even more accessible for vertical farm systems. Furthermore, such a system helps to predict an optimal harvest time.

Additionally, monitoring the chlorophyll A/B ratio on all batches allows correlation between chlorophyll A/B ratio and resulting quality. This information can be used to further optimize the radiation recipes, e.g., through machine learning.

FIG. 2A is a flow chart illustrating an embodiment of a method for irradiating a plurality of plants. This method may be performed by a system as described above. A step 21 comprises irradiating the plurality of plants in accordance with a first radiation recipe. The irradiation may be performed by an irradiation system as described above. The first radiation recipe can be optimized for light use efficiency and/or rapid growth of the plant. The first light recipe may induce a decrease in chlorophyll A/B ratio in the plurality of plants. In a typical example, the first radiation recipe comprises a relatively high amount of red and/or far-red light, and a relatively low amount of blue or ultraviolet light. For example, the amount of red radiation may be 80 % or more, or even 85 % or more. The amount of far-red radiation may be at least 6 %, usually between 6-12 %. Adding more far-red radiation may increase fresh weight, but typically does not further increase light use efficiency.

A step 23 comprises receiving or determining a chlorophyll A/B ratio in at least one of the plurality of plants. Step 23 is typically performed by a data processing system as described above.

In a step 25, the chlorophyll A/B ratio, or a value derived thereof, is compared to an absolute or relative threshold value. Step 25 is typically performed by a data processing system as described above.

The threshold value may be predetermined or may be determined dynamically. For example, the threshold value may depend on a variable such as number of days until scheduled harvest. The threshold value may depend on earlier measurements on the same plant, the same plurality of plants, or different plants of the same species. For example, the threshold value may be determined relative to an earlier determined initial chlorophyll A/B ratio. The threshold value may be defined for a value derived of the chlorophyll A/B ratio, for example, a time-derivative. The threshold value may depend on the species or variety of the plant being grown. A combination of threshold values can also be used, e.g., an absolute value of the chlorophyll A/B ratio may be compared to a first threshold value and a time-derivative of the chlorophyll A/B ratio may be compared to a second threshold value.

If the comparison yields that a criterion has not been met, the method returns to step 21 and the irradiation system continues to irradiate the plurality of plants in accordance with a first radiation recipe. Typically, steps 23 and 25 will be repeated, possibly periodically, until the criterion is met. As described above, the threshold value may vary over time, so each execution of step 25 may involve a comparison with a different threshold value. Naturally, the threshold value can also be constant, so that each comparison is with the same threshold value.

If the comparison yields that the criterion has been met, the method moves to step 27 comprising irradiating the plurality of plants in accordance with a second radiation recipe, different from the first radiation recipe. The second radiation recipe may increase the chlorophyll A/B ratio in the plurality of plants. For example, the second radiation recipe may be optimized for increasing the shelf-life of the plurality of plants, or parts thereof.

Consequently, the second radiation recipe may be said to have shelf-life increasing properties, in particular higher shelf-life increasing properties than the first radiation recipe.

In some embodiments, steps 23 and 25, and, depending on the outcome of the comparison, steps 21 and/or 27 may be repeated once or more. If that is the case, the threshold value may depend on the most recently applied radiation recipe. For example, if the chlorophyll A/B ratio is below a lower threshold value, the system may switch from the first radiation recipe to the second radiation recipe, and if the chlorophyll A/B ratio is above an upper threshold value, the system may switch from the second radiation recipe to the first radiation recipe. The threshold criterion may thus include a lower and upper threshold of chlorophyll A/B ratio for switching back and forth between the first radiation recipe and the second radiation recipe, with the range of chlorophyll A/B values between the lower and upper threshold being a hysteresis range.

Those skilled in the art understand that one could also switch to a third radiation recipe, that has an even higher blue content, if the chlorophyll A/B ratio needs a boost, for example because the harvesting needs to happen in a short time. Similarly, one could switch to a fourth radiation recipe that has an amount of blue light that is in between the first and second recipes, when there is sufficient time until harvest and such fourth recipe increasing the chlorophyll A/B ratio at a lower rate but at a higher light use efficiency.

As was discussed above, in some embodiments, a chlorophyll A/B ratio is determined or received repeatedly. In these embodiments, the chlorophyll A/B ratio is typically determined (updated) based on new measurements. The frequency of these measurements may depend on the measurement method. An updated chlorophyll A/B ratio may be determined, e.g., every minute, every hour, every day, twice a week, weekly, or every two weeks. The update frequency can also depend on external factors, e.g., every hour when the lighting is on, and not when the lighting is off, or only on days when human interaction with the plurality of plants is scheduled.

FIG. 2B is a flow chart illustrating essentially the same embodiment as FIG. 2A, except that this method may be performed entirely by a data processing system. Steps 23 and 25 may be as described above for FIG. 2A.

Additionally, a step 22 comprises instructing the irradiation system to irradiate the plurality of plants in accordance with the first radiation recipe, and a step 28 comprises instructing the irradiation system to irradiate the plurality of plants in accordance with the second radiation recipe. For example, the data processing system may instruct the irradiation system by generating, using a processor of the data processing system, and transmitting, using a communication interface of the data processing system, control signals to the irradiation system.

FIG. 3 is a flow chart illustrating another embodiment of the method irradiating a plurality of plants. Again, step 21 comprises irradiating, with the irradiation system, the plurality of plants in accordance with a first radiation recipe, and step 23 comprises receiving or determining, with the data processing system, a chlorophyll A/B ratio in at least one of the plurality of plants.

A step 29 comprises comparing, with the data processing system, the chlorophyll A/B ratio, or a value derived thereof, with a plurality of absolute or relative threshold values. Based on the outcome of these comparisons, one of a plurality of second radiation recipes is selected, and the plurality of plants is irradiated in accordance with the selected second radiation recipe 27₁₋ₙ.

Optionally, steps 23, 29, and 27₁₋ₙ may be repeated, possibly leading to the selection of a different radiation recipe in different iterations.

In an alternative embodiment, the second radiation recipe may be determined by the data processing system, based on the chlorophyll A/B ratio and/or the total carotenoid concentration. The second radiation recipe may be determined, e.g., based on algorithmic rules, based on machine learning methods, or using other suitable methods implemented by the data processing system.

The method illustrated in FIG. 3 may be adapted to be executed entirely by the data processing system, analogous to what has been described with reference to FIG. 2B.

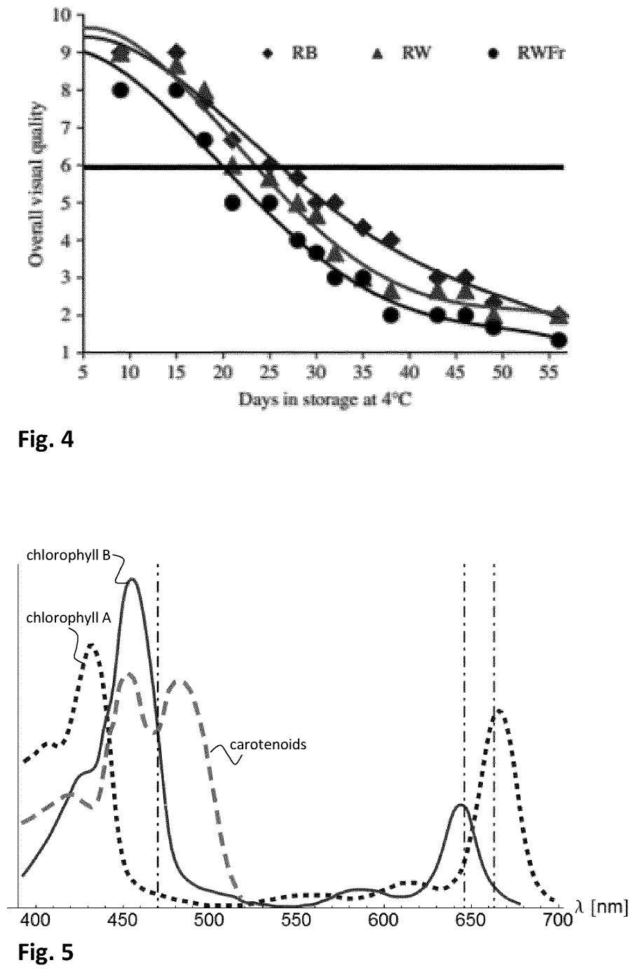

FIG. 4 is a graph showing the effect of light spectrum on shelf-life for wild rocket. This figure was obtained from Nicole et al. ‘Chapter 1.4: Postharvest quality of leafy greens growing in a plant factory’, in: Anpo et al. eds., Plant Factory using Artificial Lighting (Elsevier 2019) pages 33-43, which is hereby incorporated by reference.

FIG. 4 shows the Overall Visual Quality (OVQ) against the number of days in storage at 4° C., for three different light spectra: red/white (RW, triangles), red/blue (RB, diamonds), and red/white/far-red (RWFr, circles). The overall visual quality crosses the consumer acceptance line (OVQ=6) at 24 days, 26 days, and 20 days, respectively. Each data point is the average of the overall visual quality of three individual samples. The plants were grown under the respective spectrum for the entire crop cycle, i.e., from seedling to harvest.

Thus, when comparing the number of days in storage after which the overall visual quality drops below the consumer acceptance line for the different light spectra, the addition of far-red light to reference red/white light reduces shelf-life, whereas the addition of blue light to reference red/white light increases shelf-life.

FIG. 5 is a graph representing the absorption spectrum of chlorophyll A (dotted line), chlorophyll B (solid line) and total carotenoids (dashed line) in leaves, respectively. As chlorophyll A and B have substantially different absorption spectra, absorption-based methods may be used to determine the (relative) quantities of chlorophyll A and B, as well as the total carotenoids.

FIG. 6 is a graph showing the relation between the relative amount of far-red in the radiation recipe and the chlorophyll A/B ratio. The chlorophyll A/B ratio is shown for green baby lettuce (squares) and red (circles) baby lettuce; the lines are just a guide to the eye.

FIG. 7 is a graph showing the effect of a pre-harvest treatment on the total concentration of carotenoids in Arugula (rucola or rocket). In particular, the figure shows total carotenoids (in mg/g), using a pre-harvest treatment with high blue spectrum (left bars, labelled A and AB), versus no pre-harvest treatment (right bars, labelled BC and C), after lor 2 days extraction in 80% acetone. In this graph, the letters (A, AB, BC, and C) indicate statistically relevant differences. If two treatments share the same letter, or partially share the same letter, like A and AB, they cannot be considered different. Conversely, if two treatments do not share the same letter (e.g., one is AB and the other is C), then they are different based on the statistical method that was used and the selected confidence interval. In this case, the used statistical method is the Fisher Pairwise comparisons least significant difference (LSD) method, with a 95% confidence.

FIG. 8 depicts a block diagram illustrating a data processing system as claimed in an embodiment.

As shown in FIG. 8, the data processing system 100 may include at least one processor 102 coupled to memory elements 104 through a system bus 106. As such, the data processing system may store program code within memory elements 104. Further, the processor 102 may execute the program code accessed from the memory elements 104 via a system bus 106. In one aspect, the data processing system may be implemented as a computer that is suitable for storing and/or executing program code. It should be appreciated, however, that the data processing system 100 may be implemented in the form of any system including a processor and a memory that is capable of performing the functions described within this specification.

The memory elements 104 may include one or more physical memory devices such as, for example, local memory 108 and one or more bulk storage devices 110. The local memory may refer to random access memory or other non-persistent memory device(s) generally used during actual execution of the program code. A bulk storage device may be implemented as a hard drive or other persistent data storage device. The processing system 100 may also include one or more cache memories (not shown) that provide temporary storage of at least some program code in order to reduce the number of times program code must be retrieved from the bulk storage device 110 during execution.

Input/output (I/O) devices depicted as an input device 112 and an output device 114 optionally can be coupled to the data processing system. Examples of input devices may include, but are not limited to, a keyboard, a pointing device such as a mouse, a touch-sensitive display, an external control system referred to herein, or the like. Examples of output devices may include, but are not limited to, a monitor or a display, speakers, the LED driver, or the like. Input and/or output devices may be coupled to the data processing system either directly or through intervening I/O controllers.

In an embodiment, the input and the output devices may be implemented as a combined input/output device (illustrated in FIG. 8 with a dashed line surrounding the input device 112 and the output device 114). An example of such a combined device is a touch sensitive display, also sometimes referred to as a “touch screen display” or simply “touch screen”. In such an embodiment, input to the device may be provided by a movement of a physical object, such as, e.g., a stylus or a finger of a user, on or near the touch screen display.

A network adapter 116 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 100, and a data transmitter for transmitting data from the data processing system 100 to said systems, devices and/or networks. Modems, cable modems, and Ethernet cards are examples of different types of network adapter that may be used with the data processing system 100. The network adapter 116 may also be referred to as a communication interface 116.

As pictured in FIG. 8, the memory elements 104 may store an application 118. In various embodiments, the application 118 may be stored in the local memory 108, the one or more bulk storage devices 110, or apart from the local memory and the bulk storage devices. It should be appreciated that the data processing system 100 may further execute an operating system (not shown in FIG. 8) that can facilitate execution of the application 118. The application 118, being implemented in the form of executable program code, can be executed by the data processing system 100, e.g., by the processor 102. Responsive to executing the application, the data processing system 100 may be configured to perform one or more operations or method steps described herein.

The architecture described above for an exemplary data processing system 100 of the present invention, may also be applicable, to some extent, to an exemplary controller 7 of the irradiation system 3. For example, such exemplary controller may also include a processor for generating driver signals for the radiation sources, a communication interface for receiving control signals from the data processing system 100, an input/output device, a memory for storing radiation recipes, etc.

In another aspect, the data processing system 100 may represent a client data processing system. In that case, the application 118 may represent a client application that, when executed, configures the data processing system 100 to perform the various functions described herein with reference to a “client”. Examples of a client can include, but are not limited to, a personal computer, a portable computer, a mobile phone, or the like.

In yet another aspect, the data processing system 100 may represent a server. For example, the data processing system may represent an (HTTP) server, in which case the application 118, when executed, may configure the data processing system to perform (HTTP) server operations.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 102 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A system for irradiating a plurality of plants, the system comprising:
an irradiation system that is configured to irradiate the plurality of plants the irradiation system comprising:
one or more controllable radiation sources and/or one or more controllable radiation filters and/or radiation concentrators, and
a controller adapted to control operation of the one or more controllable radiations sources and/or the one or more controllable radiation filters and/or radiation concentrators; and
a data processing system comprising a communication interface or input/output device for receiving/sending signals, and a processor, the processor configured to:
receive, via the communication interface or input/output device, a ratio between chlorophyll A and chlorophyll B in at least one of the plurality of plants, and
cause, via communication interface or input/output device, the irradiation system to irradiate the plurality of plants in accordance with a first radiation recipe during a first period of time, and in accordance with a second radiation recipe, different from the first radiation recipe, during a second period of time;
wherein the processor is further configured to receive, via communication interface or input/output device an absolute or relative threshold value, and in response to the processor determining that the ratio between chlorophyll A and chlorophyll B is below the threshold value, cause, via communication interface or input/output device, the irradiation system to switch between the first radiation recipe and the second radiation recipe; and
wherein the first radiation recipe has a higher light use efficiency, LUE, than the second radiation recipe, and/or wherein the second radiation recipe has higher shelf-life increasing properties than the first radiation recipe.

2. The system of claim 1, wherein at least one of the first radiation recipe and the second radiation recipe depends on the ratio between chlorophyll A and chlorophyll B.

3. The system as claimed in claim 1, wherein the first radiation recipe comprises a higher far-red radiation dose or fraction than the second radiation recipe, and/or
wherein the first radiation recipe comprises a lower blue and/or ultraviolet radiation dose or fraction than the second radiation recipe.

4. The system as claimed in claim 3, wherein the far-red radiation dose in the first radiation recipe is at least twice as high as the far-red radiation dose in the second radiation recipe, and/or
wherein the blue and/or ultraviolet radiation dose in the second radiation recipe is at least twice as high as the blue and/or ultraviolet radiation dose in the first radiation recipe, and/or
wherein the far-red radiation dose in the first radiation recipe is determined based on the ratio between chlorophyll A and chlorophyll B, and/or
wherein the blue and/or ultraviolet radiation dose in the second radiation recipe is determined based on the ratio between chlorophyll A and chlorophyll B.

5. The system as claimed in claim 1, wherein the threshold value is between 2.5 and 3.5.

6. The system as claimed in claim 1, wherein the threshold value is defined as a fraction of an initial ratio between chlorophyll A and chlorophyll B, preferable the fraction being between 0.7 and 0.97.

7. The system as claimed in claim 1,
wherein the data processing system is further configured to receive a concentration of carotenoids in at least one of the plurality of plants, and
wherein at least one of the first radiation recipe, the second radiation recipe, or a switching moment between the first period of time and the second period of time depends on the concentration of carotenoids.

8. The system as claimed in claim 1, wherein the ratio between chlorophyll A and chlorophyll B is determined from one or more samples obtained from at least one plant.

9. The system as claimed in claim 8, further comprising an analyzer adapted to determine the ratio between chlorophyll A and chlorophyll B by:
extracting the sample in a defined amount of solvent, and
measuring absorption of the solvent using a UV/VIS spectrophotometer at a plurality of predetermined wavelengths.

10. The system as claimed in claim 1, further comprising a camera system or a near-infrared spectroscopy sensor to determine the ratio between chlorophyll A and chlorophyll B using near-infrared spectroscopy.

11. The system as claimed in claim 9, wherein the analyzer respectively the camera system or the near-infrared spectroscopy sensor is comprised in the data processing system.

12. The system as claimed in claim 1, wherein
each of the first and second radiation recipes defines, for a particular time period, one or more properties of radiation provided to the plurality of plants, wherein the one or more properties of radiation comprise at least one of:
a photon flux of the radiation as generated by the irradiation system,
a photon flux density of the radiation as received by the plurality of plants,
a spectral power distribution of the radiation generated by the irradiation system, and
a timing of the irradiation; and
wherein the data processing system is configured to cause the irradiation system to generate radiation such that the radiation has the photon flux and/or photon flux density and/or the spectral power distribution and/or the timing of the irradiation as defined by the first and second radiation recipes, respectively.

13. A computer-implemented method for irradiating a plurality of plants, the method comprising:
receiving a ratio between chlorophyll A and chlorophyll B in at least one of the plurality of plants, and
causing an irradiation system to irradiate the plurality of plants in accordance with a first radiation recipe during a first period of time, and in accordance to a second radiation recipe different from the first radiation recipe, during second period of time, and
receiving an absolute or relative threshold value, and in response to determining that the ratio between chlorophyll A and chlorophyll B is below the threshold value, causing the irradiation system to switch between the first radiation recipe and the second radiation recipe, and
wherein the first radiation recipe has a higher light use efficiency, LUE, than the second radiation recipe, and/or wherein the second radiation recipe has higher shelf-life increasing properties than the first radiation recipe.

14. A non-transitory computer readable medium comprising instructions which, when executed by a data processing system of a system, causes the system to perform the method as claimed in claim 13.

15. (canceled)

16. The system as claimed in claim 9, wherein the analyzer is comprised in the data processing system.
